(19) United States
(12) Patent Application Publication
(10) Pub. No.: US 2013/0290946 A1
(43) Pub. Date: Oct. 31, 2013

(54) INFORMATION PROCESSING APPARATUS, METHOD FOR UPDATING FIRMWARE IN INFORMATION PROCESSING APPARATUS, AND STORAGE MEDIUM FOR STORING PROGRAM

(71) Applicant: CANON KABUSHIKI KAISHA, Tokyo (JP)

(72) Inventor: Yasuhiro Iwadate, Kawasaki-shi (JP)

(73) Assignee: CANON KABUSHIKI KAISHA, Tokyo (JP)

(21) Appl. No.: 13/863,458

(22) Filed: Apr. 16, 2013

(30) Foreign Application Priority Data
Apr. 27, 2012 (JP) 2012-103836

(51) Int. Cl. G06F 9/445

(52) U.S. Cl. CPC G06F 8/65
USPC 717/168

(57) ABSTRACT

An information processing apparatus comprises a storing unit which stores a firmware that includes a base portion that is required to allow a device to operate alone, and an application portion other than the base portion; an extracting unit which extracts, in a case where the firmware stored in the storing unit is updated using new firmware, a base portion of the new firmware; an updating unit which updates the base portion of the firmware stored in the storing unit by using the base portion extracted by the extracting unit and to update the application portion of the firmware stored in the storing unit by using the application portion of the new firmware; and an performing unit which performs the base portion updated by the updating unit, even though the updating unit does not update the application portion of the firmware stored in the storing unit.

### BACKGROUND OF THE INVENTION

1. Field of the Invention

The present invention relates to an information processing apparatus for updating firmware, a method for updating firmware in the information processing apparatus, and a storage medium for storing a program.

2. Description of the Related Art

Conventionally, for example, a printer may include a scanner unit for converting a single function printer (SFP) into a multi function peripheral (MFP). The printer may also include a color-measuring unit that is provided with a color-measuring sensor and performs color measurement. In this manner, the number of products has been increased that include besides a main body device a peripheral device configured to be able to be added.

Japanese Patent Laid-Open No. 2004-21463 teaches that a driver that corresponds to the peripheral device has update control functionality, allowing automatically loading a most suitable firmware so as to perform firmware update.

However, Japanese Patent Laid-Open No. 2004-21463 has a problem in that, when firmware is updated in the main body device or the peripheral device, it takes a long time for the device to become available.

This problem is noticeable especially when the firmware in the peripheral device that is transmitted and received between a plurality of devices at the time of update of the firmware has itself a very large size, and the communication speed between the devices is low.

### SUMMARY OF THE INVENTION

An aspect of the present invention is to solve the above-mentioned problem with the conventional technology. The present invention provides an information processing apparatus that reduces, when the firmware is updated, a time period until the information processing apparatus becomes available, a method for updating firmware in the information processing apparatus, and a storage medium for storing a program.

The present invention in its first aspect provides an information processing apparatus comprising: a storing unit configured to store a firmware that includes a base portion that is required to allow a device to operate alone, and an application portion other than the base portion; an extracting unit configured to extract, in a case where the firmware stored in the storing unit is updated using new firmware, a base portion of the new firmware; an updating unit configured to update the base portion of the firmware stored in the storing unit by using the base portion extracted by the extracting unit and to update the application portion of the firmware stored in the storing unit by using the application portion of the new firmware; and an performing unit configured to perform processing the base portion updated by the updating unit, even though the updating unit does not update the application portion of the firmware stored in the storing unit.

The present invention in its second aspect provides a method for updating firmware performed in an information processing apparatus, including: extracting, in a case where the firmware stored in a storing unit is updated using new firmware, a base portion of the new firmware; updating the base portion of the firmware stored in the storing unit by using the extracted base portion of the new firmware and updating the application portion of the firmware stored in the storing unit by using the application portion of the new firmware; and performing the updated base portion, even though the application portion of the firmware stored in the storing unit is not updated.

The present invention in its third aspect provides a non-transitory computer-readable medium storing a program for causing a computer to execute each of a storing unit configured to store a firmware that includes a base portion that is required to allow a device to operate alone, and an application portion other than the base portion; an extracting unit configured to extract, in a case where the firmware stored in the storing unit is updated using new firmware, a base portion of the new firmware; an updating unit configured to update the base portion of the firmware stored in the storing unit by using the base portion extracted by the extracting unit and to update the application portion of the firmware stored in the storing unit by using the application portion of the new firmware; and an performing unit configured to perform processing the base portion updated by the updating unit, even though the updating unit does not update the application portion of the firmware stored in the storing unit.

According to the present invention, it is possible to reduce, when a firmware is updated, a time period until an information processing apparatus becomes available for a user.

Further features of the present invention will become apparent from the following description of exemplary embodiments with reference to the attached drawings.

### BRIEF DESCRIPTION OF THE DRAWINGS

FIG. 1 is a diagram illustrating a configuration of a system that includes a plurality of devices.

FIG. 2 is a diagram illustrating pieces of firmware that are stored in a main body device and in a peripheral device.

FIG. 3 is a flowchart illustrating processing procedures for updating the firmware stored in the main body device.

FIG. 4 is a flowchart illustrating processing procedures for updating the firmware stored in the peripheral device.

FIG. 5 is a block diagram illustrating a configuration relating to a example of the print control apparatus.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals are given to the same constituent elements and descriptions thereof are omitted.

System Configuration

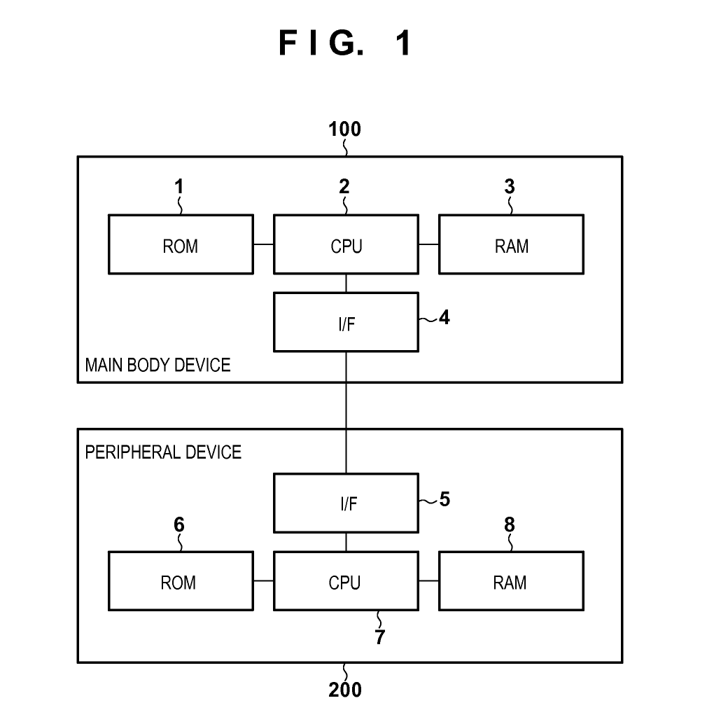

FIG. 1 is a diagram illustrating a configuration of a system that includes a plurality of devices. As illustrated in FIG. 1, in the present embodiment, a main body device 100 and a peripheral device 200 are communicatively connected to each other. The main body device 100 is a printer for example, and the peripheral device 200 is a color measuring device for example. It is sufficient that the main body device 100 and the peripheral device 200 has a relationship such that the main body device 100 functions as a host and the peripheral device 200 functions as a client. Accordingly, the main body device 100 may be a single function printer (SFP) and the peripheral device 200 may be a scanner unit, for example.

As with an information processing apparatus such as a general-purpose PC, the main body device 100 includes a ROM 1, a CPU 2, a RAM 3, and a communication interface (I/F) 4. In the case of being a printer for example, the main body device 100 includes: an image processing portion (not shown) that transfers image data of a print target at a high speed and is constituted by image buses for connecting an RIP and the like; a print control portion (not shown) that performs control over transport of a print head and printing media; and the like. The peripheral device 200 includes a communication interface (I/F) 5, a ROM 6, a CPU 7, and a RAM 8. In the case of being a color measuring device for example, the peripheral device 200 includes an optical system control portion (not shown) such as a light emitting element and a light receiving element for receiving reflected light from a patch image or the like. The main body device 100 and the peripheral device 200 can communicate with each other via the communication interfaces 4 and 5. Note that the main body device 100 and the peripheral device 200 each also include a display portion such as a display for receiving an instruction from a user, an operation panel portion such as a keyboard or a hard key with which the user gives the instruction, and a storage area such as a hard disk, these components being not shown in FIG. 1.

The main body device 100 and the peripheral device 200 respectively store firmware for controlling hardware resources of the devices in the ROM 1 and the ROM 6, which are nonvolatile memories. The firmware stored in the ROM 1 of the main body device 100 is stored while being separated into a boot program portion (also referred to as a “base portion”) that is minimally required for the main body device 100 itself operating alone and a portion other than the boot program portion, detail of the firmware will be described later. Examples of the boot program portion of the main body device 100 includes a boot program portion that is required for system boot processing for controlling the control-associated hardware resource such as the CPU 2 and a memory. Hereinafter, the portion other than the boot program portion (other than the base portion) of the firmware is referred to as an “application portion”.

The firmware stored in the ROM 6 of the peripheral device 200 is stored while being separated into a boot program portion that is minimally required for the peripheral device 200 itself operating alone, and a portion other than the boot program portion. Examples of the boot program portion of the peripheral device 200 includes a boot program portion that is required for system boot processing for controlling the control-associated hardware resource such as the CPU 7. Hereinafter, the portion other than the boot program portion of the firmware is referred to as an “application portion”.

In the present embodiment, the ROM 1 of the main body device 100 stores not only the firmware for the main body device 100 but also firmware for the peripheral device 200. The CPU 2 of the main body device 100 transmits this stored firmware for the peripheral device 200 to the peripheral device 200 in order to update the firmware stored in the ROM 6 of the peripheral device 200. By the firmware in the peripheral device 200 being updated, versions and the like can match each other between the firmware for the main body device 100 and the firmware for the peripheral device 200.

Stored State of Firmware

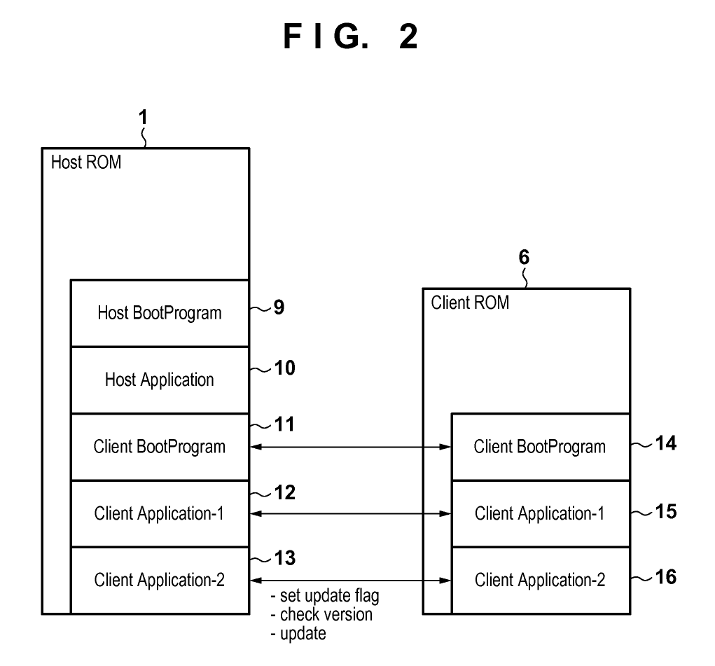

FIG. 2 is a diagram illustrating pieces of firmware that are stored in the main body device 100 and the peripheral device 200. In the present embodiment, the firmware for each device is stored in a storage area while being separated into a boot program that is required for booting the system and an application that is not required for booting the system. That is, as the firmware, there are a plurality of programs, but they are managed while being separated into a boot program and an application.

Note here that “boot program” refers to a base portion that is minimally required for each device operating alone and corresponds to the above-mentioned boot program portion. In the present embodiment, the boot program includes a program for booting and a program that is minimally required for the device operating alone. Examples of the program, other than a program for booting, that is minimally required for the device operating alone include a kernel. Also, “application” corresponds to the above-mentioned application portion.

The ROM 1 of the main body device 100 includes the firmware for the main body device 100 (firmware for the information processing apparatus) and the firmware for the peripheral device 200 (firmware for the peripheral device).

A main body device boot program 9 and a main body device application 10 in FIG. 2 correspond to the firmware for the main body device 100. The “Host Bootprogram 9” of FIG. 2 refers not only to a general program for booting but corresponds to the above-mentioned main body device boot program. Note here that the main body device boot program 9 includes a program for booting, a program minimally required for the main body device 100 itself operating alone, and a program required for transmitting update information to the peripheral device 200. Meanwhile, the main body device application 10 controls the hardware resources with respect to capability of cooperating with the peripheral device 200 (such as the capability of causing the peripheral device 200 to measure color of a patch image), for example. The firmware of the main body device 100 is updated (detail thereof will be described later) by receiving the firmware update information from an external device (not shown) such as a personal computer, a server, a USB, or the like, and storing the received firmware update information in the ROM 1. And then, the main body device 100 is rebooted and the updated program is executed to complete the update processing.

A peripheral device boot program 11 and peripheral device applications 12 and 13 of FIG. 2 correspond to the firmware for the peripheral device 200. The firmware for the peripheral device 200 refers not to a program used by the main body device 100 itself but to a program that is at least to be transmitted to the peripheral device 200. The peripheral device applications 12 and 13 control the hardware resources with respect to, for example, driving of a drying fan of the color measuring device. Although, in FIG. 2, there are shown two peripheral device applications 12 and 13, one peripheral device application may be provided or three or more peripheral device applications that correspond to intended uses may be provided. Although there is shown one main body device application 10, there may be a plurality of main body device applications.

Although, as illustrated in FIG. 2, the firmware of each device is stored in the storage area while being separated into two types, that is, a boot program and an application, a plurality of files that correspond to the boot program and to the application may be prepared by a user in advance and stored in the storage area in a separated manner. Alternatively, the main body device 100 may be configured to extract the boot program portion and the application portion with reference to header information of the firmware, and to store the extracted boot program portion and application portion, separately, in the storage area.

The ROM 6 of the peripheral device 200 stores the firmware for the peripheral device 200. A peripheral device boot program 14 and peripheral device applications 15 and 16 correspond to the firmware for the peripheral device 200. The “Client Bootprogram 14” of FIG. 2 refers not only to a general program for booting but corresponds to the above-described peripheral device boot program. Note here that the peripheral device boot program includes a program for booting, and a program minimally required for the peripheral device 200 itself operating alone.

Although processing for updating the firmware of the peripheral device 200 will be described in detail later, the firmware stored in the peripheral device 200 is updated by the firmware for the peripheral device 200 stored in the ROM 1 of the main body device 100. In other words, the firmware for the peripheral device 200 in the ROM 1 of the main body device 100 is transmitted to the peripheral device 200 to be stored in the ROM 7 of the peripheral device 200, so that the firmware stored in the peripheral device 200 is updated. In that case, for example, at this transmission, the CPU 2 of the main body device 100 instructs the CPU 7 of the peripheral device 200 about update of the firmware for the peripheral device stored in the ROM 6, which corresponds to the transmitted firmware.

Also, when the firmware has been updated in the peripheral device 200, information about the update is transmitted from the peripheral device 200 to the main body device 100 and stored in the ROM 1 of the main body device 100. Accordingly, the main body device 100 can manage the update state of the firmware of the peripheral device 200.

The peripheral device boot program 14 stored in the ROM 6 of the peripheral device 200 corresponds to the peripheral device boot program 11 stored in the ROM 1 of the main body device 100. Also, the peripheral device application 15 stored in the ROM 6 of the peripheral device 200 corresponds to the peripheral device application 12 stored in the ROM 1 of the main body device 100. Also, the peripheral device application 16 stored in the ROM 6 of the peripheral device 200 corresponds to the peripheral device application 13 stored in the ROM 1 of the main body device 100.

Firmware Update Processing

Hereinafter, procedures from the update of the firmware for the main body device 100 through the update of the firmware for the peripheral device 200 will sequentially be described.

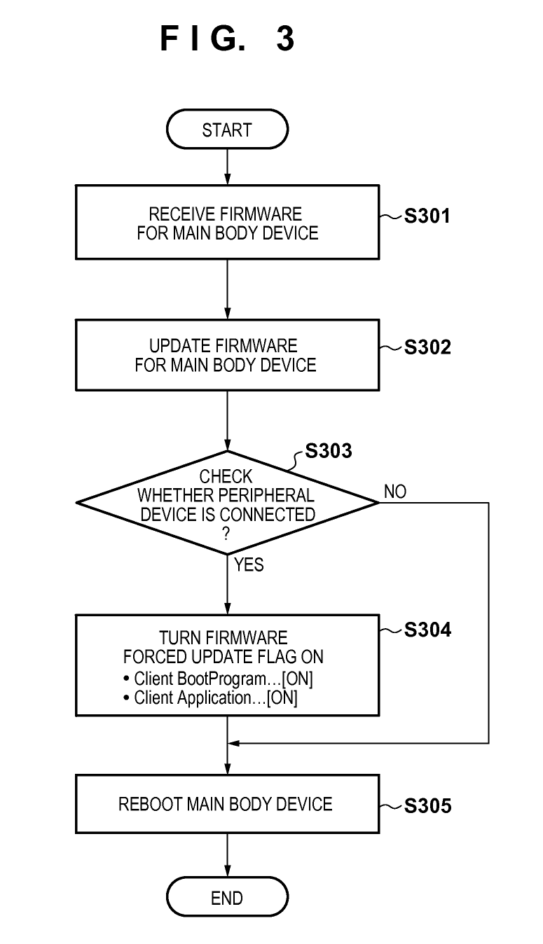

FIG. 3 is a flowchart illustrating procedures of the processing for updating the firmware for the main body device 100. The processing illustrated in FIG. 3 is processing performed by, for example, the CPU 2 of the main body device 100 executing an installer (program).

First, in step S301, the CPU 2 acquires, together with the firmware for the main body device 100, the firmware for the peripheral device 200. For example, the CPU 2 receives, from an external server device or the like, the installer in a packaged form that includes the firmware for the main body device 100 and the firmware for the peripheral device 200. The firmware of each device received in step S301 includes a boot program portion, an application portion, and a header in which address information of the portions are described. Also, the installer defines the order of execution of the programs such that update of the boot program portion is first performed.

In step S302, the CPU 2 updates the firmware of the main body device 100 by using the firmware for the main body device 100 acquired in step S301. In the present embodiment, the CPU 2 updates only the main body device boot program 9 that is currently stored in the ROM 1. Specifically, the CPU 2 first acquires a start address and an end address of the boot program portion with reference to the header of the firmware for the main body device 100 acquired in step S301, and extracts the boot program portion. Then, the CPU 2 updates the main body device boot program 9 currently stored in the ROM 1 by using this extracted boot program portion. The update processing is performed by replacing the main body device boot program 9 stored in the ROM 1 with the extracted boot program portion. At the time of this update, it is also possible to perform hash value checking using a check sum, MD5, and the like, ROM size checking, or the like so as to test appropriateness of the updated firmware. In the present embodiment, each program is developed from the ROM 1 to the RAM 3 to be executed. Therefore, the firmware stored in the ROM 1 can be updated even though each program (the main body device boot program 9, the main body device application 10) is under executing.

In this manner, according to the present embodiment, only the main body device boot program 9, instead of both the main body device boot program 9 and the main body device application 10, is first updated by using the firmware for the main body device 100 acquired in step S301. Conventionally, when updating the firmware for the main body device 100, the boot program portion and the application portion are updated altogether without being separated. Therefore, the main body device 100 is available for the user only when the system of the main body device 100 is booted after this update by performing rebooting or the like. In contrast, according to the present embodiment, since only the main body device boot program 9 is first updated at the time of update of the firmware for the main body device 100, the time period to update the minimally required portion that enables the main body device 100 to operate is reduced compared with the conventional update time period. Therefore, the main body device 100 can become available for the user sooner. With this measure, for example, an operation panel is enabled for the user or a print job instructed by the user can be processed. Also, by the system of the main body device 100 being booted, the firmware can be transmitted to the peripheral device 200 thereby being updated, without the application portion being updated, as will be described later. For example, when the main body device 100 is rebooted during the update processing of the application portion 10 for the main body device 100, only the application portion 10 can be updated again because the main body device boot program 9 is valid.

In step S303, the CPU 2 determines whether or not the peripheral device 200 is connected to the main body device 100. For example, the CPU 2 may also determine the connection by performing test communication with the CPU 7 of the peripheral device 200. If it has been determined in step S303 that the connection is established, the processing then advances to step S304. On the other hand, if it has been determined that the connection is not established, the processing then advances to step S305.

In step S304, the CPU 2 creates, for each of the peripheral device boot program 11 and the peripheral device applications 12 and 13, flag data in which a firmware forced update flag is set. Note here that “firmware forced update flag” refers to a flag for causing the peripheral device 200 to skip processing for checking version of the firmware and to forcedly start update of the firmware. Setting the firmware forced update flag eliminates the need of performing unnecessary checking, so that it is possible to update even when the versions match each other but the firmware has not appropriately been updated. In step S304, the CPU 2 sets the firmware forced update flag with respect to the peripheral device boot program 11 to be valid if the CPU 2 has determined that the peripheral device boot program 11 stored in the ROM 1 and the peripheral device boot program 14 stored in the ROM 6 of the peripheral device 200 do not match each other. For example, the CPU 2 may compare version information before the update of the peripheral device boot program 14 that is held as a backup, with current version information of the current peripheral device boot program 11, and set the firmware forced update flag to be valid if the comparison shows that the pieces of version information are different from each other. Determination of whether or not the peripheral device applications 12 and 13 match the peripheral device applications 15 and 16, respectively, is also performed in the similar manner.

In step S305, the CPU 2 reboots the main body device 100 in order to perform system boot processing by using the updated main body device boot program 9. The CPU 2 reboots the main body device 100 and confirms whether or not the main body device boot program 9 is executable. When the main body device boot program 9 is confirmed to be executable, the update processing of the main body device boot program 9 is completed. Note that, before the rebooting, the CPU 2 stores, in a storage area such as a hard disk, the main body device application 10 of the firmware for the main body device 100 and the firmware for the peripheral device 200 that ware acquired in step S301. In the present embodiment, the update processing of the main body device boot program 9 is completed with completion of the rebooting.

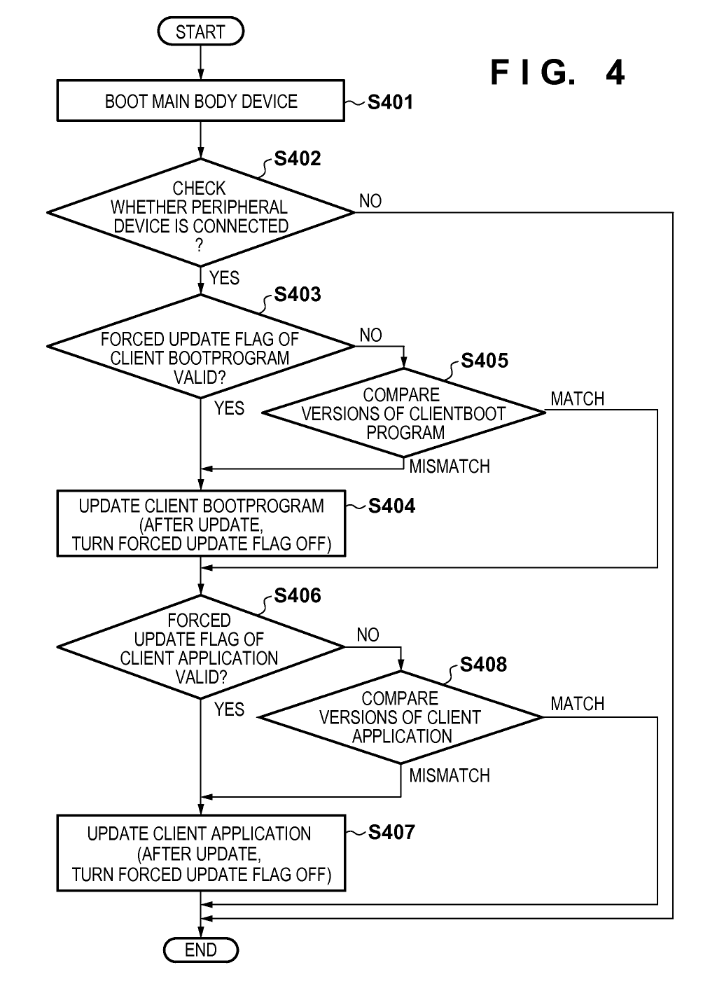

FIG. 4 is a flowchart illustrating procedures of processing for updating the firmware for the peripheral device 200. The update of the firmware for the peripheral device 200 starts after the update of the firmware for the main body device 100 (in the present embodiment, update of only the boot program of the firmware for the main body device 100) of FIG. 3. The update of the firmware for the peripheral device 200 may be performed directly after the update of the firmware of FIG. 3 if the peripheral device 200 is connected to the main body device 100 at the time of the update of the main body device 100, but is not limited thereto. If the main body device boot program 9 is updated by the procedures in FIG. 3 in the state in which the peripheral device 200 is not connected to the main body device 100, the processing for updating the firmware of the peripheral device 200 starts when the peripheral device 200 is connected to the main body device 100 after the update of the main body device boot program 9. In step S401, the CPU 2 of the main body device 100 boots the main body device 100. If the processing in step S305 of FIG. 3 is performed in the state in which the peripheral device 200 is connected to the main body device 100, step S401 corresponds to step S305 of FIG. 3.

In step S402, the CPU 2 of the main body device 100 determines, similarly to step S303, whether or not the peripheral device 200 is connected to the main body device 100. Here, if it has been determined that the peripheral device 200 is not connected to the main body device 100, the main processing of FIG. 4 ends. On the other hand, if it has been determined that the peripheral device 200 is connected to the main body device 100, the CPU 2 of the main body device 100 extracts the boot program portion and the application portion from the firmware for the peripheral device 200 that is saved before the rebooting, on the basis of the header of the firmware. The CPU 2 of the main body device 100 updates the peripheral device boot program 11 and the peripheral device applications 12 and 13 in the ROM 1 by using the boot program portion and the application portion that were extracted from the firmware for the peripheral device 200. Also, the CPU 2 of the main body device 100 transmits the flag data created in step S304 and the extracted boot program portion and application portion, separately, to the peripheral device 200 via the communication interface 4, and the processing advances to step S403.

In step S403, the CPU 7 of the peripheral device 200 determines whether or not the forced update flag with respect to the peripheral device boot program 11 is set to be valid, with reference to the flag data received from the main body device 100. Here, if it has been determined that the forced update flag is set to be valid, the processing advances to step S404. On the other hand, if it has been determined that the forced update flag is not set to be valid, the processing advances to step S405.

In step S404, the CPU 7 of the peripheral device 200 updates the peripheral device boot program 14 currently stored in the ROM 6 by using the boot program portion for the peripheral device received from the main body device 100.

If it has been determined in step S403 that the forced update flag is not set to be valid, the CPU 7 of the peripheral device 200 compares, in step S405, versions between the boot program portion for the peripheral device received from the main body device 100 and the peripheral device boot program 14 currently stored in the ROM 6. Here, if the versions do not match each other, the processing proceeds to step S404. On the other hand, if the versions match each other, the processing advances to step S406 without performing the update of the peripheral device boot program 14. Also, if, in step S403, the setting content of the forced update flag cannot be checked due to any reason, it is preferable that the peripheral device boot program 14 be updated since it is liable that the peripheral device 200 cannot appropriately be booted unless the peripheral device boot program 14 is updated. In S404, the CPU 7 updates the peripheral device boot program 14 stored in the ROM 6. In short, the peripheral device boot program 14 stored in the ROM 6 is replaced with the peripheral device boot program 11 received from the main body device 100. And, the updated peripheral device boot program 14 is returned to the main body device 100 with the forced update flag being set to invalid (OFF). And then, the process proceeds to S406.

With the processing up to here, the peripheral device boot program 14 is updated to the latest condition, that is, to the peripheral device boot program 11. In other words, in the peripheral device 200 as well, the boot program that is required for the system boot processing has updated, so that it is possible to reboot the peripheral device 200 and to enable the peripheral device boot program 14 to be valid.

As described above, according to the present embodiment, only the peripheral device boot program is first updated also with respect to the peripheral device 200. Therefore, also with respect to the peripheral device 200, the time period to update the minimally required portion that enables the peripheral device 200 to operate is reduced compared with a conventional update time period, as a result, enabling the peripheral device 200 to become available for the user sooner (for example, the peripheral device 200 is set in accordance with an instruction of the user, and the like).

Also, on the main body device 100 side, the processing of the main body device 100 itself can be performed parallel to the updating processing of the peripheral device boot program 14 in steps S403 to S405 in the peripheral device 200. That is, since the CPU 2 of the main body device 100 can transmit the peripheral device boot program to the peripheral device 200 at a timing during the updating processing of the main body device application 10 for the main body device 100 itself, it is possible to perform the update processing of the firmware for the main body device 100 and the update processing of the firmware for the peripheral device 200 parallel to each other. Consequently, the entire configuration of the main body device 100 and the peripheral device 200 can become available for the user sooner than the conventional system.

Also, as described in step S404 in FIG. 4, after the peripheral device boot program 14 stored in the ROM 6 has been updated, the CPU 7 of the peripheral device 200 sets the forced update flag to be invalid, and returns the forced update flag to the main body device 100. With this return, the CPU 2 of the main body device 100 can recognize that the peripheral device boot program in the peripheral device 200 has been updated. Note that if the peripheral device 200 is not appropriately booted after the update of the peripheral device boot program, it is considered that a communication error or a firmware transmission and reception error has occurred, and error display is performed with the display or the like and an LED or the like. Here, the peripheral device boot program 14 is valid by rebooting the peripheral device 200. And, the peripheral device 200 is rebooted and is confirmed to be in an executable condition to complete the update processing of the peripheral device boot program 14.

The processing in or after step S406 relates to processing for updating the peripheral device application. The processing in or after step S406 may be performed at a timing during the update processing of the firmware for the main body device 100 or at another timing. For example, the processing may be performed at a timing during idling or before sleep processing of the main body device 100 after the updating processing of the firmware or at a timing before or during execution of the peripheral device application.

In FIG. 4, when having received the boot program portion and the application portion for the peripheral device from the main body device 100, the CPU 7 of the peripheral device 200 autonomously updates only the peripheral device boot program 14 first. However, the CPU 2 of the main body device 100 may perform control such that it transmits only the boot program portion for the peripheral device to the peripheral device 200 during the system booting of the main body device 100 and lets the peripheral device 200 update only the boot program portion for the peripheral device. Also in this case, in the peripheral device 200, only the peripheral device boot program 14 is updated. Also, the CPU 2 of the main body device 100 may then perform control such that it transmits the application portion to the peripheral device 200 and lets the peripheral device 200 update the application portion. In this case, as described above, the application portion may be transmitted at a timing during the updating processing of the application portion of the firmware for the main body device 100, at a timing during idling of the main body device 100 after the updating processing of the firmware, at a timing before the sleep processing, at a timing before or during execution of the peripheral device application of the main body device 100, for example.

Also, since there can be a plurality of peripheral device applications, it is possible to define a timing for updating each peripheral device application. Assume, for example, that the main body device 100 is a large printer and the peripheral device 200 is a color measuring device. In this case, it is possible to update the peripheral device application relating to a drying fan at a timing during a lamp adjustment of a color-measuring sensor of the color measuring device. Alternatively, it is also possible to update the peripheral device application relating to the color measuring carriage at a timing during drying processing of the patch-printed material in the color measuring device. Accordingly, by updating the peripheral device application that is subjected to update while another application is being executed, it is possible to improve convenience without causing the user to be concerned about a time period in which the application is updated.

Here, the update processing of the peripheral device application is described below. In step S406, the CPU 7 of the peripheral device 200 determines whether or not a forced update flag with respect to the peripheral device application 12 is set to be valid, with reference to the flag data received from the main body device 100. Here, if it has been determined that the forced update flag is set to be valid, the processing then advances to step S407. On the other hand, if it has been determined that the forced update flag is not set to be valid, the processing then advances to step S408.

In step S407, the CPU 7 of the peripheral device 200 updates the peripheral device applications 15 and 16 respectively, that are currently stored in the ROM 6, by using the application portions (the peripheral device applications 12 and 13) for the peripheral device received from the main body device 100. After the update, the CPU 7 of the peripheral device 200 sets the forced update flag to be invalid, and returns the forced update flag to the main body device 100. With this return, the CPU 2 of the main body device 100 can recognize that the peripheral device application of the peripheral device 200 has been updated.

If it has been determined in step S406 that the forced update flag is not set to be valid, the CPU 7 of the peripheral device 200 compares, in step S408, versions between the application portion (the peripheral device applications 12) for the peripheral device received from the main body device 100 and the peripheral device application 15 currently stored in the ROM 6. Here, if the versions do not match each other, the processing of step S407 is performed. On the other hand, if the versions match each other, the update of the peripheral device application 15 is not performed. The CPU 7 of the peripheral device 200 executes update of the peripheral device application 16 in the similar manner as the procedure in steps S406 to S408.

In the present embodiment, as illustrated in FIG. 2, each of the main body device 100 and the peripheral device 200 stores in its ROM an entire firmware, that is, a boot program and an application. However, it is also possible that the boot program and the application are stored in different storage areas. For example, the system boot program, which is unlikely to be updated, may be stored in a flash ROM region, and the application, which is likely to be updated, may be stored in a RAM region so that the speed at which the program is executed is facilitated.

When updating the peripheral device boot program 14 through the peripheral device application 16, the CPU 7 of the peripheral device 200 may transmit, before the update, the peripheral device boot program 14 through the peripheral device application 16 to the main body device 100. As a result, the main body device 100 can hold, as backups, the peripheral device boot program 14 through the peripheral device application 16 before the update.

As described above, in the present embodiment, the main body device 100 stores the firmware for the main body device in the storage area such that the firmware is separated into two types of a boot program and an application, so that the boot program and the application can be updated separately. As a result, the main body device 100 updates only the boot program of the firmware first, making it possible to reduce an update time period and to make the devices become available for the user sooner, than a conventional configuration in which pieces of firmware are updated altogether. Therefore, for example, if some processing is required to be performed soon after the firmware for the main body device 100 is updated, updating the main body device boot program 9 and rebooting is enough. As a result, the main body device boot program 9 is in an executable condition. If the power supply of the main body device 100 is shut down while updating the main body device application 10 after the main body device boot program 9 is updated, the main body device boot program 9 is able to be valid by booting the main body device 100. Updating the main body device application 10 may be performed after the main body device boot program 9 is updated. Here, the main body device 100 may be rebooted after the main body device application 10 is updated.

Also, since the main body device is configured so as to store the firmware for the peripheral device 200, the main body device 100 appropriately operates, even if the peripheral device 200 is not connected to the main body device 100, so as to be able to receive and store information about the update of the firmware for the peripheral device. Therefore, if the firmware for the peripheral device 200 is received externally when the peripheral device 200 is disconnected from the main body device 100 for example, the main body device 100 can update the firmware for the peripheral device 200 when the peripheral device 200 is again connected to the main body device 100. This can prevent versions or the like of the firmware from being mismatched between the main body device 100 and the peripheral device 200.

Also, in the main body device 100, the firmware for the peripheral device is stored in the storage area while being separated into two types of a boot program and an application. Accordingly, the main body device 100 can transmit only the boot program to the peripheral device 200, so that it is possible to reduce an amount of data that is transmitted together. Therefore, even if the communication speed between the main body device 100 and the peripheral device 200 is low, it is possible to transmit the boot program in a short time. Also, even when the peripheral device 200 is connected to the main body device 100 and the main body device 100 updates the firmware of the peripheral device 200, it is possible, by updating only the boot program first, to reduce an update time period and to make the peripheral device 200 available for the user sooner.

Also, since the main body device 100 needs only to transmit the peripheral device boot program to the peripheral device 200 in the system boot processing after the rebooting, it is possible to execute system booting of both devices in parallel to each other, enabling the entire devices to become available for the user sooner.

Note that a timing at which the main body device application 10 in the ROM 1 is updated by using the application portion that has been extracted on the basis of a header of the firmware for the main body device 100 acquired in step S301 is not specifically limited. For example, the main body device application 10 in the ROM 1 may be updated after the main body device boot program 9 is updated in step S302 or after the firmware for the peripheral device is transmitted to the peripheral device 200. And, the CPU 2 confirms whether or not the main body device application 10 is executable. Then, the update processing is completed. Here, the main body device 100 may be rebooted. However, it is not necessary to reboot the main body device 100, if the main body device boot program 9 has been updated.

Also, although, in the present embodiment, the main body device is rebooted after the steps S303 and S304 so that the main body device boot program is updated, the main body device boot program may be updated after step S302 without checking whether or not the peripheral device is connected.

Although the present embodiment is configured such that the main body device 100 is connectable to the peripheral device 200, the effect of the present invention can be attained even if there is only the main body device 100 in which the firmware for the main body device is stored while being separated into a boot program and an application. Note that, although in the present embodiment, the firmware for the main body device is separated into the main body device boot program 9 and the main body device application 10, the firmware for the main body device may not be separated. If only the firmware for the peripheral device is separated into the boot program and the application, the update time period in which the peripheral device 200 updates the firmware for the peripheral device can be reduced, making it possible for the time period until the peripheral device 200 can become available for the user to be reduced.

Although, in the main body device 100, the firmware for the peripheral device is stored in the ROM 1 in a separated manner, the main body device 100 may store the firmware for the peripheral device in a non-separated manner, and may transmit the firmware to the peripheral device 200. In this case, the CPU 7 of the peripheral device 200 may first update only the boot program 14 stored in the ROM 6. For example, the CPU 7 acquires the start address and the end address of the boot program portion with reference to a header of the received firmware, and extracts the boot program portion. Then, the CPU 7 may update the boot program 14 currently stored in the ROM 6 by using the extracted boot program portion. Although, in the present embodiment, the updated program is executable after rebooting, the program may be then executed without rebooting if the update can be reflected without rebooting.

In the present embodiment, each program stored in the ROM 1 is developed into the RAM 3 to be executed. However, the present embodiment is not limited to such a configuration. For example, each program stored in the ROM 1 may be developed into the storage device (not shown) such as a HDD of the main body device 100. If the main body device 100 includes a plurality of ROMs, each program stored in the ROM 1 may be developed into one writable ROM of the ROMs.

### OTHER EMBODIMENTS

As previously described, the functional blocks illustrated in FIG. 1 may be configured in various manners, different from the distribution of the respective blocks illustrated in FIG. 1, by appropriately dividing the blocks into individual processing units or control units, or integrating several blocks.

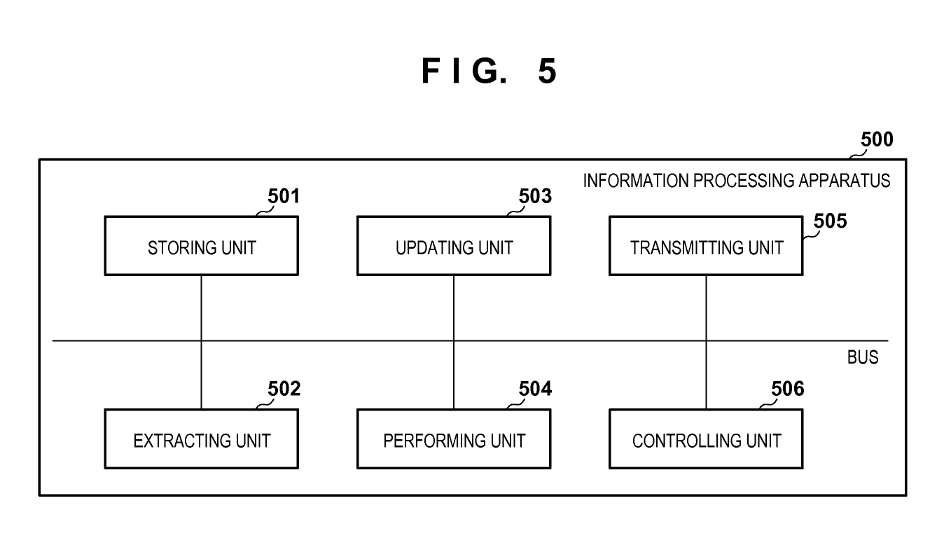

For example, the functional flocks of FIG. 1 may be configured as the information processing apparatus 500 including the storing unit 501 which stores a firmware that includes a base portion that is required to allow a device to operate alone, and an application portion other than the base portion, the extracting unit 502 which extracts, in a case where the firmware stored in the storing unit 501 is updated using new firmware, a base portion of the new firmware, the updating unit 503 which updates the base portion prior to the application portion of the firmware by using the base portion extracted by the extracting unit 502, and the performing unit 504 which performs processing for enabling the base portion updated by the updating unit 503, as shown in FIG. 5.

And, the information processing apparatus 500 may include the transmitting unit 505 which transmits separately to the peripheral device the base portion and the application portion of the firmware for the peripheral device, and the controlling unit 506 which controls the peripheral device so as to perform the update by using the base portion and the application portion of the firmware for the peripheral device transmitted by the transmitting unit.

Further, in the present exemplary embodiment, the CPU 2 executes a program to implement the processing in FIGS. 3 and 4. However it is not limited thereto. For example, the CPU 2 does not need to execute entire processing, and each of the units illustrated in FIG. 5 may be realized by hardware such as an ASIC. In addition, part of the units may be realized by hardware, and part of the units may be realized by software.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-103836, filed Apr. 27, 2012, which is hereby incorporated by reference herein in its entirety.

What is claimed is:

1. An information processing apparatus comprising:
a storing unit configured to store a firmware that includes a base portion that is required to allow a device to operate alone, and an application portion other than the base portion;
an extracting unit configured to extract, in a case where the firmware stored in the storing unit is updated using new firmware, a base portion of the new firmware;
an updating unit configured to update the base portion of the firmware stored in the storing unit by using the base portion extracted by the extracting unit and to update the application portion of the firmware stored in the storing unit by using the application portion of the new firmware; and
an performing unit configured to perform the base portion updated by the updating unit, even though the updating unit does not update the application portion of the firmware stored in the storing unit.

2. The information processing apparatus according to claim 1,
wherein the storing unit stores the firmware for the information processing apparatus such that the firmware is separated into a base portion that is required to allow the information processing apparatus to operate alone, and an application portion other than the base portion.

3. The information processing apparatus according to claim 1,
wherein the information processing apparatus is capable of communicating with a peripheral device,
the storing unit stores a firmware for the peripheral device such that the firmware is separated into a base portion that is required to allow the peripheral device to operate alone and an application portion other than the base portion, and
the information processing apparatus further comprises a transmitting unit configured to transmit separately to the peripheral device the base portion and the application portion of the firmware for the peripheral device.

4. The information processing apparatus according to claim 3,
wherein the transmitting unit transmits the base portion of the firmware for the peripheral device and then the application portion of the firmware for the peripheral device.

5. The information processing apparatus according to claim 3,
wherein, in a case where the storing unit stores the firmware for the information processing apparatus such that the firmware is separated into a base portion that is required to allow the information processing apparatus to operate alone and an application portion other than the base portion, the transmitting unit transmits the base portion of the firmware for the peripheral device to the peripheral device after the updating unit has updated the base portion of the firmware for the information processing apparatus and before the updating unit updates the application portion of the firmware for the information processing apparatus.

6. The information processing apparatus according to claim 5, further comprising:
a controlling unit configured to control the peripheral device so as to perform the update by using the base portion and the application portion of the firmware for the peripheral device transmitted by the transmitting unit.

7. The information processing apparatus according to claim 1,
wherein the extracting unit extracts the base portion of the new firmware and the application portion of the new firmware, with reference to a header of the new firmware.

8. The information processing apparatus according to claim 1, wherein the updating unit updates the base portion of the firmware stored in the storing unit prior to the application portion of the firmware stored in the storing unit.

9. The information processing apparatus according to claim 1, the performing unit performs the base portion of the firmware before the application portion of the firmware is updated.

10. The information processing apparatus according to claim 1,
wherein, after the performing by the performing unit, the updating unit updates the application portion of the firmware stored in the storing unit by using the application portion of the new firmware.

11. The information processing apparatus according to claim 1,
wherein the performing unit performs the base portion after rebooting the information processing apparatus.

12. A method for updating firmware performed in an information processing apparatus, including:
extracting, in a case where the firmware stored in a storing unit is updated using new firmware, a base portion of the new firmware;
updating the base portion of the firmware stored in the storing unit by using the extracted base portion of the new firmware and updating the application portion of the firmware stored in the storing unit by using the application portion of the new firmware; and
performing the updated base portion, even though the application portion of the firmware stored in the storing unit is not updated.

13. The method according to claim 12, wherein the base portion of the new firmware and the application portion of the new firmware are extracted with reference to a header of the new firmware.

14. The method according to claim 12, wherein the base portion of the firmware stored in the storing unit is updated prior to the application portion of the firmware stored in the storing unit.

15. The method according to claim 12, wherein the base portion of the firmware is performed before the application portion of the firmware is updated.

16. The method according to claim 12, wherein, after performing the basic portion, the application portion of the firmware stored in the storing unit is updated by using the application portion of the new firmware.

17. The method according to claim 12, wherein the base portion is performed after rebooting the information processing apparatus.

18. A non-transitory computer-readable medium storing a program for causing a computer to execute each unit defined in claim 1.
